(19) United States
(12) Patent Application Publication
(10) Pub. No.: US 2007/0002723 A1
(43) Pub. Date: Jan. 4, 2007

(54) Signaling network ID in TPS bits

(75) Inventors: Jani Vare, Kaarina (FI); Arto Hamara, Turku (FI); Jarno Kallio, Turku (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/148,326

(22) Filed: Jun. 9, 2005

(51) Int. Cl. H04J 11/00

(52) U.S. Cl. 370/203

(57) ABSTRACT

Methods and system for transmitting a DVB-H network ID in transmission parameter signaling (TPS) data are described. A sixteen bit DVB-H network ID may be divided into four four-bit portions, and each four-bit portion may be included in an orthogonal frequency division multiplex (OFDM) TPS frame transmitted by the DVB-H network. Because each OFDM TPS frame also includes a frame order of that frame within its corresponding super-frame, a receiver of the TPS data can reassemble the network ID by ordering the four received portions according to the frame order of the respective OFDM TPS frames in which they were received. The sixteen bit DVB-H network ID may alternatively be divided into two eight-bit portions, and each eight-bit portion may be included in the cell_ID bits of two frames of a super-frame.

### FIELD OF THE INVENTION

The invention relates generally to mobile telecommunications networks and systems. More specifically, the invention relates to transmission of parameter information and the inclusion of a network ID in transmission parameter signaling (TPS) data bits in a mobile telecommunications network.

### BACKGROUND OF THE INVENTION

Digital broadcasting systems, such as various DVB-T (Terrestrial Digital Video Broadcasting) and DAB (Digital Audio Broadcasting) systems, ATSC, ISDB and other similar broadcasting systems allow for a system of transmitters arranged in a cellular fashion, allowing signal reception of a suitable quality over a geographical area through suitable transmitter site selection. The cellular nature of the transmitters' coverage allows mobile receivers to be able to achieve satisfactory performance even when moving. Steps are being taken to incorporate DVB receivers into mobile telephones and Personal Digital Assistants (PDAs), for which applications the DVB standards were not initially designed. Steps are also being taken to provide services over DVB transmissions. A user may buy services using, for example, the telephone or other data transceiver forming part of the mobile telephone or PDA.

A receiver, on decoding the transmission parameter information like the Transmission Parameter Signaling (TPS) data in DVB for a received signal, can use it in certain decision making processes. In particular, a DVB-T receiver in a mobile device can use the cell identification information to eliminate some candidate signals in a handover procedure.

A form of DVB is being tailored for use in mobile receiver environments. This is known as DVB handheld, or DVB-H. In DVB-H, Internet Protocol datacast (IPDC) services are time-sliced, resulting in data for a service being transmitted over a relatively short period of time with relatively high bandwidth. A mobile receiver then needs to receive data only during this short period of time, and its receiver can be switched off at other times. This has positive implications for power consumption in the mobile receiver. Time-slicing is not limited to DVB-H.

In known systems, however, each receiver cannot distinguish between signals that are part of different DVB-H networks based on present TPS informnation. Presently, TPS bits only offer the following information for identifying different signals: cell_id, DVB-H, and MPE_Fec indicator. Frequency is known when synchronization is attempted and succeeded. Thus the parameters used only include: cell_id, frequency and DVB-H/MPE-FEC indicators.

If a receiver selects a handover candidate and performs a signal scan, the receiver may attempt to distinguish networks on the basis of TPS information. However, the network can only be affirmatively distinguished if existing networks are always configured in a way such that no multiple {frequency, cell_id} pairs exist. This places unnecessary restrictions on network setup, and thus cannot be guaranteed. In addition, the network_id would still be required for ensuring that the received signals are those that are actually sought by the receiver. The network_id is currently only available by analyzing the Network Information Table (NIT), and it can take up to 10 seconds to receive the NIT for each signal received by the receiver.

Thus, it would be an advancement in the art to address the above limitations, and to provide a faster way to determine the DVB network from which a signal originates.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to transmission of a network ID over TPS data bits. An aspect of the invention provides a mobile terminal, which includes a processor controlling operation of the mobile terminal, configured with a receiver to receive a digital video broadcasting for handhelds (DVB-H) signal including transmission parameter signal (TPS) data, where the mobile terminal can read a network ID from the TPS data. The mobile terminal may read the network ID, e.g., by receiving a plurality of consecutive TPS frames, each TPS frame storing a portion of the network ID, and determining the network ID based on the portion of the network ID received in each of the plurality of consecutive TPS frames, and based on a frame order associated with each of the plurality of consecutive TPS frames. Other aspects of the invention provide methods and computer readable media associated therewith.

According to another illustrative aspect of the invention, a DVB-H network node in a DVB-H network may include a wireless transmitter configured to wirelessly transmit a network ID corresponding to the DVB-H network in transmission parameter signaling (TPS) data. The network node may transmit the network ID, e.g., by dividing the network ID into a plurality of portions, sending a plurality of consecutive TPS frames, each TPS frame including a different portion of the plurality of portions of the network ID.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a simplified example of a digital video broadcasting system in which one or more illustrative aspects of the invention may be implemented.

FIG. 2 illustrates a block schematic diagram of a transmitter that may be used with one or more illustrative aspects of the invention.

FIG. 3 illustrates a block schematic diagram of an integrated receiver/decoder (IRD) that may be used in conjunction with one or more illustrative aspects of the invention.

FIG. 4A illustrates a superframe divided into four OFDM frames over which a network ID is transmitted according to an illustrative embodiment of the invention.

FIG. 4B illustrates a superframe divided into four OFDM frames over which a network ID is transmitted according to another illustrative embodiment of the invention.

FIG. 5 illustrates a method for using the transmitted network ID in a receiver to select a desired signal from a list of signal candidates according to one or more illustrative aspects of the invention.

FIG. 6 illustrates network information for a first network in an illustrative scenario according to one or more aspects of the invention.

FIG. 7 illustrates network information for a second network in the illustrative scenario according to one or more aspects of the invention.

FIG. 8 illustrates a cellular architecture in which the illustrative scenario may take place, according to one or more aspects of the invention.

### DETAILED DESCRIPTION OF THE INVENTION

In the following description of the various embodiments, reference is made to the accompanying drawings, which form a part hereof, and in which is shown by way of illustration various embodiments in which the invention may be practiced, e.g., providing one or more advances in the areas of DVB-H, TPS bit information, and OSI layer 1 signaling. It is to be understood that other embodiments may be utilized and structural and functional modifications may be made without departing from the scope of the present invention.

The standards document EN 300 744 V1.5.1 (2004-06) published by the European Telecommunications Standards Institute (ETSI) specifies TPS carriers, which are used for signaling parameters related to the transmission scheme used. The TPS carriers are constituted at a physical layer, or OSI layer 1, of the communication protocol stack. The decoding of the TPS in a receiver allows the channel coding and modulation used in the transmission to be determined, which information is used in controlling the receiver to operate accordingly. The TPS data is defined over 68 consecutive OFDM (Orthogonal Frequency Division Multiplex) symbols, referred to as one OFDM Frame. The TPS data is transmitted in parallel on seventeen TPS carriers for the DVB 2K mode, and on 68 carriers for the 8K mode. Every TPS carrier in the same symbol conveys the same differentially encoded information bit. The TPS is transmitted as shown in Table 1.

TABLE 1

| Bit (Symbol) | |
|---|---|
| Number | Description |
| S₀ | Initialization |
| S₁-S₁₆ | Synchronization Word |
| S₁₇-S₂₂ | TPS Length Indicator |
| S₂₃-S₂₄ | Frame Number (in a Super Frame) |
| S₂₅-S₂₆ | Constellation (QPSK or 16 or 64 QAM) |
| S₂₇-S₂₉ | Hierarchy Information |
| S₃₀-S₃₂ | Code Rate, HP Stream |
| S₃₃-S₃₅ | Code Rate, LP Stream |
| S₃₆-S₃₇ | Guard Interval |
| S₃₈-S₃₉ | Transmission Mode (2k or 8k) |
| S₄₀-S₄₇ | Cell Identifier |
| S₄₈-S₄₉ | DVB-H signaling |
| S₅₀-S₅₃ | (Reserved for future use) |
| S₅₄-S₆₇ | Error Correction (BCH Code) |

It should be noted that the synchronization word takes one value for odd numbered frames and the inverse for even numbered frames in a Super-Frame. Also, the cell identifier is two bytes long, and is divided between successive Frames.

More important to some decision-making processes is the information received as service information (SI), which is described in detail in DVB standards document ETS 300468. The standard document ISO/IEC13818-1 specifies SI, which is referred to as Program Specific Information (PSI). The PSI/SI data provides information for enabling automatic configuration of a receiver to demultiplex and decode the various streams of programs within the multiplex signal. The PSI/SI data includes a Network Information Table (NIT), which provides information relating to the physical organization of the multiplexes, also known as TransportStreams (TS), carried via a given network. A receiver can store the NIT contents, to attempt to minimize access time when switching between channels. The PSI/SI data forms part of the data layer, or OSI layer 2, of the communication protocol stack.

A receiver, also known as an Integrated Receiver/Decoder (IRD) detects parameters of a prevailing signal and/or network by filtering and parsing a received PSI/SI table. From this information, an IRD can determine whether or not a signal is a valid handover candidate. However, since typically PSI/SI tables may be transmitted in any interval from 25 milliseconds to 10 seconds, depending on the table (e.g., maximum interval for NIT table is 10 seconds), and since the PSI/SI information is transmitted on a data layer (e.g., OSI level 2), signal scanning and handover processes can be expected to involve utilization of a significant amount of the processing, receiver and power resources of the IRD, as well as being time consuming. This is of particular importance as regards power consumption in battery-operated mobile handheld devices.

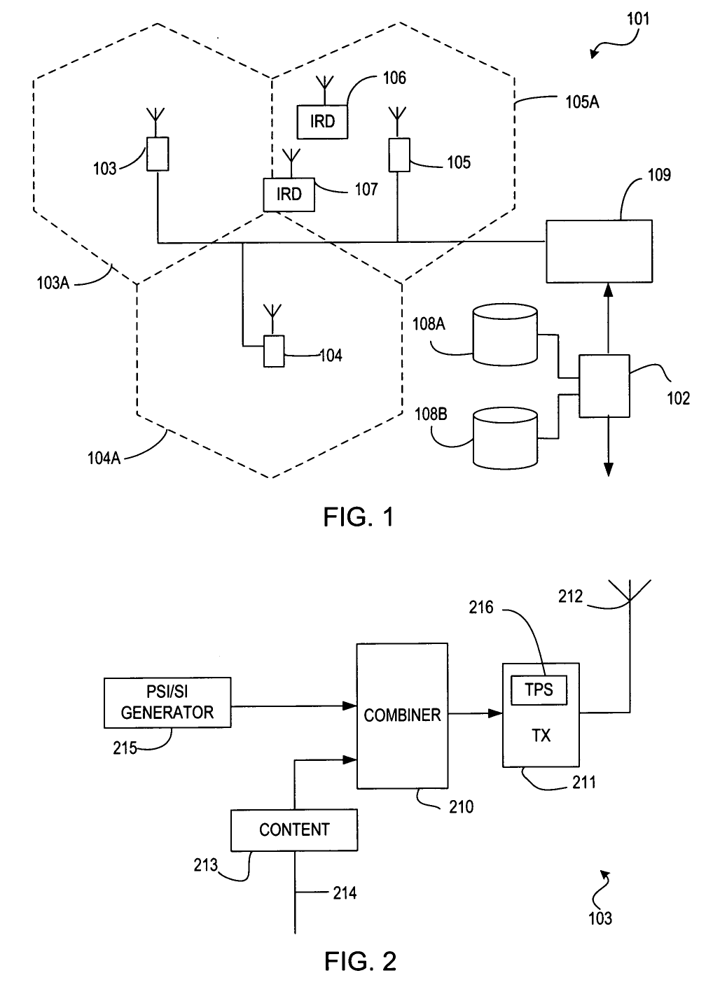

Referring to FIG. 1, a digital video broadcasting (DVB) system is shown generally at 101. The system comprises a content provider 102, which is connected by suitable links to each of first, second and third transmitter stations 103, 104, 105. The transmitter stations 103-105 are separated from each other at locations selected such as to provide suitable coverage of the surrounding geography. In FIG. 1, the transmitters 103-105 are shown having respective coverage areas 103A, 104A and 105A, although it will be appreciated that in practice the area covered by a given transmitter will not be so regular and that there will be significant amount of overlap between the coverage areas 103A-105A. Also shown in FIG. 1 are first and second integrated receiver/decoders (IRD) 106, 107. The content provider 102 has access to sources of content 108A, 108B, such as audio-visual content, data files or images. The content is transmitted using IP over DVB-T network, in what is known as an Internet Protocol Data Cast (IPDC) service, and preferably using time-slicing, to one or more of the IRDs 106, 107, which are configured to receive data from at least two different communication channels. The IRDs 106, 107 in this embodiment may be mobile devices that may be incorporated in mobile telephones or personal digital assistants (PDA), for example.

The content data is transmitted to a network element 109, which is a server configured to receive the content data and to generate recovery data for use in forward error correction of the content data. The content data is transmitted to the IRDs 106, 107 via the transmitters 103-105. The recovery data is transmitted to the IRDs in one embodiment of the invention via a second communication channel provided for example by a Third Generation (3G) mobile network (not shown). It should be noted that the communication paths for the content and recovery data are described with reference to and shown in FIG. 1 in a simplified form. However, other elements such as further transmitters, network elements or networks may be situated in these communication paths Each IRD 106, 107 is able to receive and decode signals transmitted by any or all of the transmitters 103-105. Each of the transmitters 103-105 is substantially the same, and one is illustrated in FIG. 2.

Referring to FIG. 2, a transmitter station 103 is shown in schematic form, comprising generally a data source in the form of a combiner 210, a transmitter 211 and an antenna 212. The combiner 210 receives input data from a content provider 213, which is connected via an input 214 to the content provider 102 shown in FIG. 1.

Also arranged to provide data to the combiner is a Program Specific Information (PSI) (or Service Information (SI)) data generator 215. The transmitter 211 includes a transmission parameter signaling (TPS) data generating device 216. The combiner 210 is arranged to source data from the content provider device 213 and the PSI/SI generator device 215 and to provide a data stream according to the DVB standards for inclusion with TPS data and subsequent transmission by the transmitter 211.

According to the DVB broadcasting standards, data provided by the TPS generator 216 is included in the physical layer of the transmitted signals many times a second, whereas the PSI/SI generating device 215 data is included in the data layer of the transmitted signal and much less frequently, with up to 10 second intervals between data transmissions. As is conventional the PSI/SI generator 215 generates data representing a network information table (NIT), which is in accordance with the DVB standards. The transmitter 211 can therefore be considered to include transmission parameter information provided by the TPS generator 216 with service information provided as part of-the data generated by the PSI/SI generator 215. The resultant signal can be considered as a composite signal, and it is the composite signal which is then transmitted by the transmitter 211 by way of the antenna 212. Of course, the composite signal also includes content data provided by the content generator 213, and optionally other data which is outside the scope of this disclosure.

Each of the transmitters 103-105 may transmit plural signals according to the DVB standards. In this connection, the transmitters 103-105 may include plural physical transmitters at a single location and sharing a common antenna. Each signal transmitted by a given one of the transmitters 103-105 may differ from other signals in terms of the frequency of the signal, the network type, the format of the transport stream, the network's topology, the transmitter power, and the nature of the multiplexing used. For example, multiplexing may be in a time-sliced nature, which is conceptually similar to time division multiplexing, or it may be that multiplexing is effected other than in the time domain. The types of transport stream which might be used will be known by those skilled in the art. The network type might be, for example, a DVB network or an Internet Protocol Data Cast (IPDC) network.

The topology of the network might be single frequency or multiple frequency. A multiple frequency network might have transmissions on plural contiguous frequency bands. The DVB standards allow for bandwidths of 5, 6, 7 and 8 MHz. For example, the implementation of DVB in Europe utilizes signals having a bandwidth of 8 MHz.

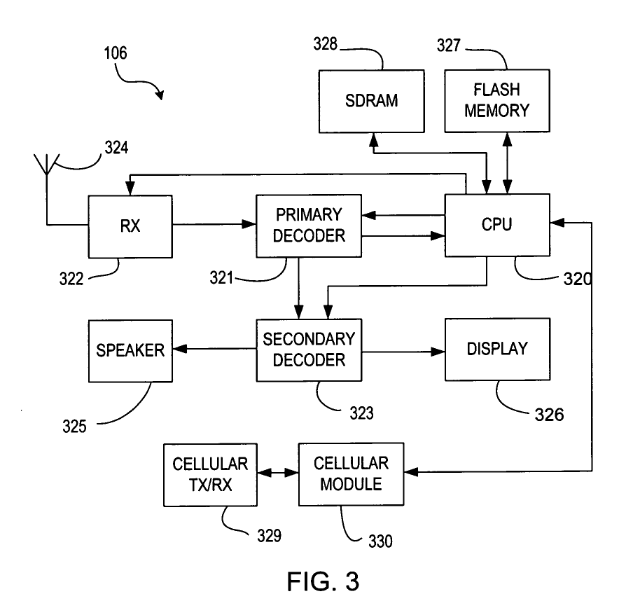

The IRD 106, 107 will now be described with reference to FIG. 3. Referring to FIG. 3, the IRD 106 is shown schematically, comprising generally a central processing unit (CPU) 320, which is connected to control each of a primary decoder 321, a receiver 322, a secondary decoder, e. g. an MPEG-2 and IP (Internet Protocol) decoder 323, to a non-volatile flash memory 327, and to a volatile memory 328, e.g., SDRAM.

The receiver 322 is connected to receive radio frequency signals via an antenna 324, and to provide demodulated signals to the decoder 321. The primary decoder 321 is arranged under control of the CPU 320 to provide decoded data both to the CPU and to provide MPEG or IP data to the secondary decoder 323. The secondary decoder 323 provides audio outputs to a speaker 325 and visual outputs to a display 326, whereby audiovisual content present in the signal received at the receiver 322 can be presented to a user. Although in this example IP and MPEG signals are able to be processed by a common decoder 323, it will be appreciated that separate decoders could be used instead.

The flash memory 327 is used to store data parsed from an NIT during signal scan. The volatile memory 328 is used to store some of the data used in earlier stages of a handover procedure.

In this embodiment, the IRD 106 also includes a transceiver 329 for allowing communication in a mobile telephone system, such as e.g., GSM, GPRS, 3G, UMTS for example, which is coupled to a corresponding mobile telephone and data handling module 330. The transceiver 329 and the module 330 allow the IRD 106 to operate as a telephone and mobile Internet portal, as well as to allow the user of the IRD to subscribe to services of interest which are communicated by data cast using the DVB network. This can be achieved in any convenient manner. For example, the user might send a request for service delivery to a mobile telephone operator with which the user subscribes using the UMTS components 329, 330. The operator may then arrange for the service to be provided via DVB using an Internet service provider. Notifications of service delivery may be communicated to the IRD using the UMTS system or the DVB system.

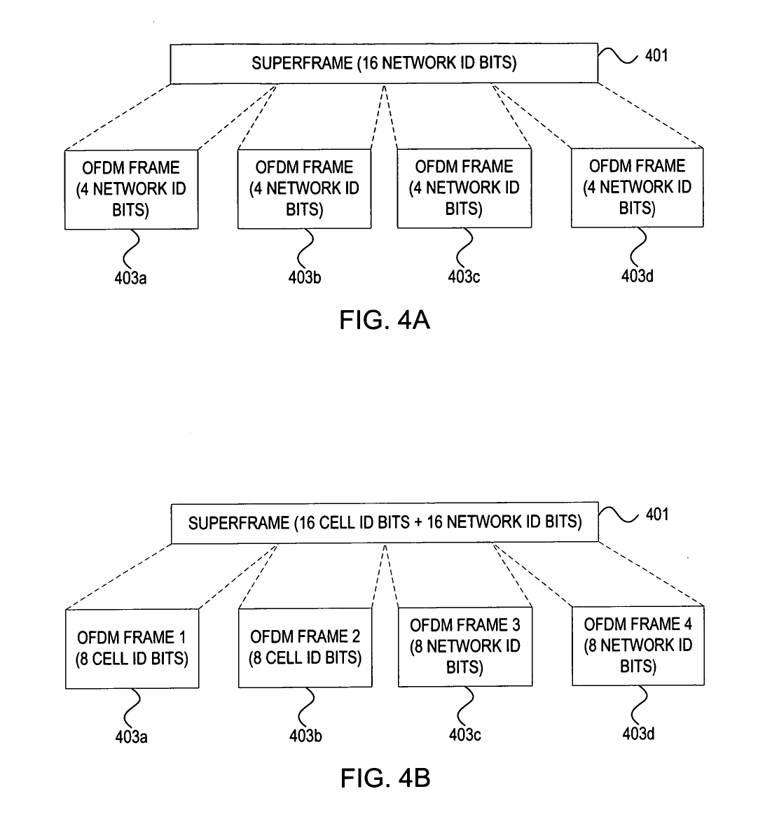

The IRD 106 differs from conventional IRDs in that it is arranged to detect network ID information forming part of the TPS data, and to utilize that data appropriately. In a first illustrative embodiment, with reference to FIG. 4A, a 16 bit network ID may be transmitted in a single superframe 401, e.g., by splitting the network ID bits among four sequential OFDM frames 403a, 403b, 403c, and 403d in the superframe. Each OFDM frame carries 68 TPS bits, and each OFDM frame 403 in the superframe 401 may carry four bits of the network ID, e.g., in bits S₅₀-S₅₃. Each receiver can then reconstruct the network ID from any four sequential OFDM frames, based on the portion of the network ID received in each OFDM frame and the corresponding OFDM frame number (i.e., bit S₂₃-S₂₄) of each frame. For example, if the receiver begins storing the network ID from OFDM frame 3 of a superframe, the receiver knows that the next frame (frame 4) is the final portion of the network ID, the following frame (frame 1) will carry the first portion of the network ID, and the following frame (frame 2) will carry the second portion of the network ID.

In a second illustrative embodiment, with reference to FIG. 4B, a 16-bit network ID may also be transmitted in a single superframe, but without using reserved bits (e.g., without using bits S₅₀-S₅₃). In such an embodiment, the network ID may be transmitted by reusing the cell_ID bits S₄₀-S₄₇ in one or more frames, thus saving any reserved bits for further use while still gaining the benefits of the present invention. The use of the cell_ID bits in DVB-T is minimal and thus existing systems will at most be minimally affected by such a change. Thus, according to the present illustrative embodiment, the eight bits S₄₀ to S₄₇ may be used to identify the cell and network from which the signal originates. The most significant bytes of the cell_ID, i.e., b15-b8, may be transmitted in frame 1 of each super-frame. The least significant bytes of the cell_id, i.e., b7-b0, may be transmitted in frame 2 of each super-frame. The most significant bytes of the network_ID, i.e., b15-b8, may be transmitted in frame 3 of each super-frame. The least significant bytes of the network_ID, i.e., b7-b0, may be transmitted in frame 4 of each super-frame. The mapping of bits according to this illustrative embodiment is shown below in Table 2. If the provision of the cell_ID or network_ID is not foreseen then the eight bits may be set to zero.

TABLE 2

| TPS | | | | |
|---|---|---|---|---|
| bit number | Frame 1 | Frame 2 | Frame 3 | Frame 4 |
| S₄₀ | cell_id b₁₅ | cell_id b₇ | network_id b₁₅ | network_id b₇ |
| S₄₁ | cell_id b₁₄ | cell_id b₆ | network_id b₁₄ | network_id b₆ |
| S₄₂ | cell_id b₁₃ | cell_id b₅ | network_id b₁₃ | network_id b₅ |
| S₄₃ | cell_id b₁₂ | cell_id b₄ | network_id b₁₂ | network_id b₄ |
| S₄₄ | cell_id b₁₁ | cell_id b₃ | network_id b₁₁ | network_id b₃ |
| S₄₅ | cell_id b₁₀ | cell_id b₂ | network_id b₁₀ | network_id b₂ |
| S₄₆ | cell_id b₉ | cell_id b₁ | network_id b₉ | network_id b₁ |
| S₄₇ | cell_id b₈ | cell_id b₀ | network_id b₈ | network_id b₀ |

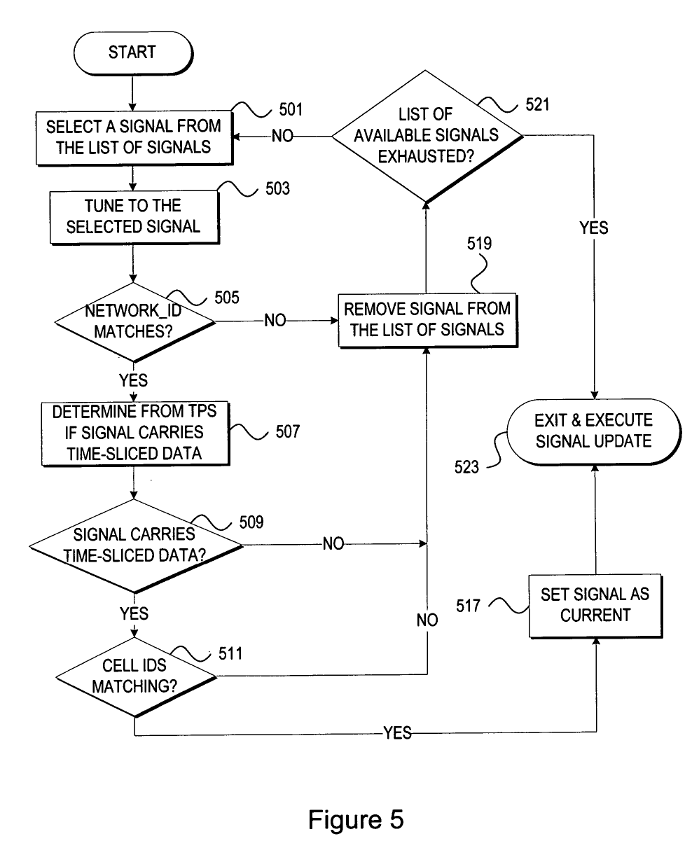

FIG. 5 illustrates a method utilizing one or more illustrative aspects of the invention. The method begins at step 501 with a list of candidate or otherwise available signals. The list may be provided by a variety of sources, or may be created by IRD 106, e.g., by performing a signal scan procedure as is known in the art. The list may alternatively be provided to IRD 106 as a file storing signal information for all possible signals in the region where the IRD 106 presently resides. At step 503, a receiver, e.g., IRD 106, selects a test signal from the list of available signals, and in step 505 the receiver determines whether the network ID matches a sought signal, e.g., by analyzing four consecutive OFDM frames as described with respect to FIG. 4A or 4B. If the network ID does not match the sought signal, then the method skips to step 519, described below. If, however, in step 505 the network ID matches the sought signal, then the method proceeds to step 507, where the receiver determines from the TPS data whether the signal carries time-sliced data. In step 509, if the receiver determines that the signal does not carry time-sliced data, the method skips to step 519, described below. If in step 509 the receiver determines that the signal does carry time-sliced data, then the method proceeds to step 511.

In step 511, the receiver determines whether the cell ID defined by bits S₄₀-S₄₇ matches an expected cell ID. If the cell ID does not match the expected cell ID, then the method skips to step 519, described below. If in step 511 the cell ID matches the expected cell ID, then the method proceeds to set the test signal as the new current signal in step 517, and terminates in step 523 by performing a signal update procedure, e.g., by performing a handover to the new current signal.

In step 519 the receiver removes the test signal from the list of candidate signals, and proceeds to step 521, where the receiver determines whether any candidate signals remain to be tested. If there are remaining candidate signals, the method returns to step 501 for selection of another test signal. If in step 521 there are no remaining candidate signals, the method terminates in step 523 by performing the signal update procedure, e.g., indicating that an acceptable signal could not be found.

It will be appreciated that the procedure shown in FIG. 5 provides a particularly convenient scheme for eliminating unsuitable signal candidates from a list of available signals for handover. This is made possible because information indicating the network ID is provided in the TPS data, thereby allowing the receiver to more quickly determine whether a test signal is the proper signal to which a handover should be performed. Although in the above embodiment, certain bits of the TPS data are allocated to certain defined purposes, it will be appreciated that strict adherence to this scheme is not essential. On the contrary, of the four TPS data bits which are currently reserved for future use, any number of them may be used to implement one or more of the embodiments of the invention described herein.

Including the network ID in the TPS data bits as described herein saves power in receivers, as the network ID can be determined faster, without waiting up to ten seconds for each signal which must be tested. The system and method described provide a robust signaling scheme for providing the network ID, allowing receivers to distinguish between signals of different DVB-H networks, and also negating the need to synchronize configurations between different overlapping DVB-H networks. These advantages, whether taken alone or together, improve the end-user experience by reducing delay during the handover process.

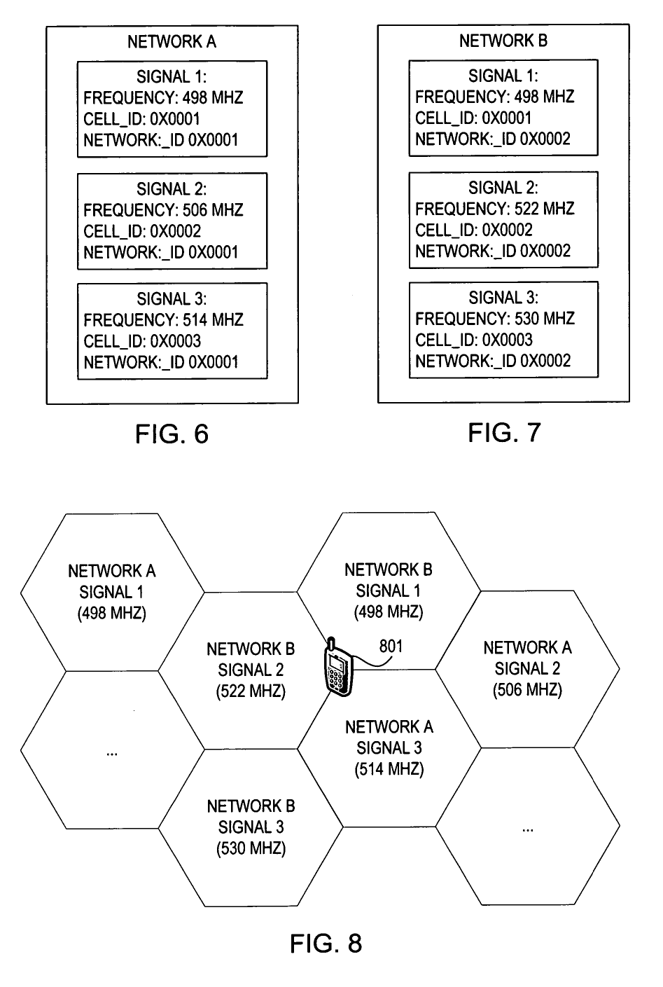

FIGS. 6-8 illustrate a sample scenario of a handover process according to one or more illustrative aspects of the invention. FIG. 6 illustrates network information for a first DVB-H network, Network A. FIG. 7 illustrates network information for a second DVB-H network, Network B. FIG. 8 illustrates a sample cell architecture for Network A and Network B. Assume that receiver 801 is presently consuming signals part of network A. FIGS. 6-8 illustrate a situation where receiver 801 performs a handover and selects a signal from the available candidates.

By tuning to frequencies based on a previously received NIT of Network A, the receiver 801 will detect three candidates, signals 1-3. Without the benefit of the present invention, if receiver 801 uses TPS bits to detect that the correct signals are found, the receiver 801 cannot be sure of which signals are part of which network. Thus, the receiver 801 might incorrectly assume that signal 1 of Network B is the proper signal, since the cell_id and frequency match the expected cell_id and frequency as identified by Network A. To ensure that the network is correct the receiver 801 must receive and analyze the NIT, which may consume up to 10 seconds, to confirm that the network_id is correct. Upon determining that the network is incorrect, the receiver 801 must start over, and perhaps receive another incorrect signal, requiring another ten seconds to detect that it is incorrect.

With the benefit of one or more aspects of the invention, however, the receiver 801 can quickly determine whether the candidate signal is provided by the correct network by analyzing the network_id TPS data bits in four consecutive OFDM frames (or in frames 3 and 4 according to the embodiment of FIG. 4B). Symbol duration is between 231 μs-1,120 μs in an 8MHz channel, depending on the mode and guard interval. Each OFDM frame contains 68 symbols, and 4 OFDM frames make one super-frame. Thus, the maximum time to receive an entire super-frame is approximately 304.64 ms, which is orders of magnitude faster than the 10 seconds it may take to otherwise receive the NIT and determine the network ID from the NIT, as discussed above.

One or more aspects of the invention may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

I/We claim:

1. A mobile terminal, comprising:
a processor controlling operation of the mobile terminal;
a receiver configured to receive a digital video broadcasting for handhelds (DVB-H) signal including transmission parameter signal (TPS) data;
a memory for storing computer readable instructions that, when executed by the processor, cause the mobile terminal to read a network ID from the received TPS data.

2. The mobile terminal of claim 1, wherein the mobile terminal determines the network ID by performing steps of:
(a) receiving a plurality of consecutive OFDM frames, each OFDM frame storing a portion of the network ID; and
(b) determining the network ID based on the portion of the network ID received in each of the plurality of consecutive OFDM frames, and based on a frame order associated with each of the plurality of consecutive OFDM frames.

3. The mobile terminal of claim 2, wherein the plurality of consecutive OFDM frames consists of four OFDM frames, each of the four OFDM frames storing a different four bits of a sixteen bit network ID, and each of the four OFDM frames also storing a frame number of that frame within a superframe.

4. The mobile terminal of claim 2, wherein the plurality of consecutive OFDM frames consists of two OFDM frames, each of the two OFDM frames storing a different eight bits of a sixteen bit network ID, and each of the two OFDM frames also storing a frame number of that frame within a superframe.

5. The mobile terminal of claim 4, wherein each of the two OFDM frames stores the different eight bits in TPS bit numbers S₄₀-S₄₇.

6. The mobile terminal of claim 1, wherein the computer readable instructions, when executed by the processor, further cause the mobile terminal to make a handover decision based on the read network ID from the TPS data.

7. A computer-assisted method performed in a mobile terminal, said method comprising steps of:
a mobile terminal receiving a network ID in transmission parameter signal (TPS) data transmitted by a DVB-H network; and
the mobile terminal making a handover decision based on the received network ID.

8. The method of claim 7, wherein receiving a network ID in TPS data comprises:
(a) receiving a plurality of consecutive OFDM frames, each OFDM frame storing a portion of the network ID, such that the network ID can be created using the portion of the network ID from each of the plurality of consecutive OFDM frames; and
(b) assembling the network ID using the portions of the network ID received in each of the plurality of OFDM frames based on a frame order of each of the plurality of OFDM frames.

9. The method of claim 8, wherein the plurality of consecutive OFDM frames consists of four OFDM frames, each of the four OFDM frames storing a different four bits of a sixteen bit network ID, and each of the four OFDM frames also storing a frame number of that frame within a superframe, and wherein the frame order is based on the received frame numbers.

10. The method of claim 9, wherein the plurality of consecutive OFDM frames consists of two OFDM frames, each of the two OFDM frames storing a different eight bits of a sixteen bit network ID, and each of the two OFDM frames also storing a frame number of that frame within a superframe.

11. The method of claim 10, wherein each of the two OFDM frames stores the different eight bits in TPS bit numbers S₄₀-S₄₇.

12. A computer readable medium storing computer executable instructions for performing the method of claim 7.

13. A DVB-H network node in a DVB-H network, said DVB-H node comprising a wireless transmitter configured to wirelessly transmit a network ID corresponding to the DVB-H network in transmission parameter signaling (TPS) data.

14. The DVB-H network node of claim 13, wherein the DVB-H node is configured with computer executable instructions which, when executed, cause the DVB-H transmitter to wirelessly transmit the network ID by performing a method comprising steps of:
(a) dividing the network ID into a plurality of portions; and
(b) sending a plurality of consecutive OFDM frames, each OFDM frame including a different portion of the plurality of portions.

15. The DVB-H network node of claim 14, wherein step (a) comprises dividing the network ID into four portions; and wherein step (b) comprises sending four consecutive TPS frames, each TPS frame including a different one of the four portions.

16. The DVB-H network node of claim 15, wherein each of the four consecutive OFDM frames further includes a frame number of that frame within a corresponding OFDM superframe.

17. The DVB-H network node of claim 14, wherein the plurality of consecutive OFDM frames consists of two OFDM frames, each of the two OFDM frames storing a different eight bits of a sixteen bit network ID, and each of the two OFDM frames also storing a frame number of that frame within a superframe.

18. The DVB-H network node of claim 10, wherein each of the two OFDM frames stores the different eight bits in TPS bit numbers S₄₀-S₄₇.

19. A mobile terminal, comprising:
a processor controlling operation of the mobile terminal;
a receiver configured to receive a digital video broadcasting for handhelds (DVB-H) signal including transmission parameter signal (TPS) data;
a memory for storing computer readable instructions that, when executed by the processor, cause the mobile terminal to perform a method for reading a sixteen-bit network ID from the TPS data, said method comprising steps of:
(a) receiving four consecutive orthogonal frequency division multiplex (OFDM) TPS frames from a DVB-H transmitter, each OFDM TPS frame communicating a different four-bit portion of the network ID, and each OFDM TPS frame further communicating a frame number of that OFDM TPS frame within a corresponding superframe, wherein each superframe consists of four OFDM TPS frames;
(b) assembling the network ID by ordering the four different portions of the network ID according to the frame number of each of the four OFDM TPS frames; and
(c) making a handover decision based on the network ID.

20. A mobile terminal, comprising:
a processor controlling operation of the mobile terminal;
a receiver configured to receive a digital video broadcasting for handhelds (DVB-H) signal including transmission parameter signal (TPS) data;
a memory for storing computer readable instructions that, when executed by the processor, cause the mobile terminal to perform a method for reading a sixteen-bit network ID from the TPS data, said method comprising steps of:
(a) receiving two consecutive orthogonal frequency division multiplex (OFDM) TPS frames from a DVB-H transmitter, each OFDM TPS frame communicating a different eight-bit portion of the network ID, and each OFDM TPS frame further communicating a frame number of that OFDM TPS frame within a corresponding superframe, wherein each of the two OFDM frames stores the different eight bits in TPS bit numbers S₄₀-S₄₇;
(b) assembling the network ID by ordering the two different portions of the network ID according to the frame number of each of the four OFDM TPS frames; and
(c) making a handover decision based on the network ID.
